(19) United States
(12) Patent Application Publication
(10) Pub. No.: US 2025/0356669 A1
(43) Pub. Date: Nov. 20, 2025

(54) MODEL FOR OBJECT DETECTION, CLASSIFICATION, AND SEGMENTATION

(71) Applicant: NEC Laboratories America, Inc., Princeton, NJ (US)

(72) Inventor: Eric Cosatto, Red Bank, NJ (US)

(21) Appl. No.: 19/202,010

(22) Filed: May 8, 2025

Related U.S. Application Data
(60) Provisional application No. 63/648,770, filed on May 17, 2024.

(51) Int. Cl. G06V 20/69; G06V 10/26; G06V 10/764; G06V 10/82

(52) U.S. Cl. CPC G06V 20/698; G06V 10/267; G06V 10/764; G06V 10/82; G06V 20/695; G06V 2201/03

(57) ABSTRACT

Methods and systems for image analysis include processing an input image with a convolutional model that generates classification maps and a segmentation map. Pixels are identified in the classification maps that correspond to intensity peaks to detect objects. Object boundaries are generated in the segmentation map around the pixels to segment objects. Objects are classified using the object boundaries and the pixels to associate regions of the input image with respective classes. An action is performed responsive to the objects.

### RELATED APPLICATION INFORMATION

This application claims priority to U.S. Patent Application No. 63/648,770, filed on May 17, 2024, incorporated herein by reference in its entirety.

### BACKGROUND

### Technical Field

The present invention relates to computer vision models and, more particularly, to a model that can perform multiple tasks at once.

### Description of the Related Art

Computer vision models perform a variety of tasks on input images, such as object detection, classification, and segmentation. These models underlie a variety of significant tasks, where artificial intelligence can be leveraged to automate processes that previously required the intervention of a human being.

### SUMMARY

A method for image analysis includes processing an input image with a convolutional model that generates classification maps and a segmentation map. Pixels are identified in the classification maps that correspond to intensity peaks to detect objects. Object boundaries are generated in the segmentation map around the pixels to segment objects. Objects are classified using the object boundaries and the pixels to associate regions of the input image with respective classes. An action is performed responsive to the objects.

A system for image analysis includes a hardware processor and a memory that stores a computer program. When executed by the hardware processor, the hardware processor causes the hardware processor to process an input image with a convolutional model that generates plurality of classification maps and a segmentation map, to identify pixels in the classification maps that correspond to intensity peaks to detect objects, to generate object boundaries in the segmentation map around the pixels to segment objects, and to classify objects using the object boundaries and the pixels to associate regions of the input image with respective classes, and to perform an action responsive to the objects.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an image analysis model that is used to perform object detection, classification, and segmentation, in accordance with an embodiment of the present invention;

FIG. 2 is a block/flow diagram of a method of training and using a method to perform object detection, classification, and segmentation, in accordance with an embodiment of the present invention;

FIG. 3 is a block diagram of a healthcare facility where image analysis is used to diagnose and treat disease, in accordance with an embodiment of the present invention;

FIG. 4 is a block diagram of a computing device that can perform object detection, classification, and segmentation, in accordance with an embodiment of the present invention;

FIG. 5 is a diagram of a neural network architecture that can be used to implement part of a convolutional model, in accordance with an embodiment of the present invention; and

FIG. 6 is a diagram of a deep neural network architecture that can be used to implement part of a convolutional model, in accordance with an embodiment of the present invention.

### DETAILED DESCRIPTION OF PREFERRED EMBODIMENTS

The tasks of object detection, classification, and segmentation are often performed by separate machine learning models that either detect objects and assign them a rough bounding box, or that segment image areas without specifically detecting instances of objects separately. Performing these tasks simultaneously can help in some situations, such as in the case of analyzing microscopy images for pathology, where instances of objects (e.g., tumor cells) need to be counted while they are simultaneously assigned a type and while their contours are extracted for fine-grained analysis.

For example, when analyzing a tumor micro-environment on stained tissue images from cancer patients, models that predict patient stratification may use cell nuclei features that are extracted as described herein. In the field of satellite imaging, counts and morphological features of extracted objects, such as vehicles and buildings, can be used for intelligence gathering. In these examples, large images are processed at high resolution to process all visible objects. Performing the different tasks at the same time can greatly speed the analysis.

To that end, a fully convolutional deep learning model may be used to analyze input images and to output a set of maps that represent the outputs of the tasks. When training the model, target maps are generated from annotated training images. In a post-processing phase, objects and features are extracted from the maps. The model may generate N+1 maps, where N is a number of object classes. The first N maps are used to train detection and classification tasks, while the additional map is used to train segmentation. The post-processing functions may include peak detection, seed-based region growing, and the efficient extraction of lists of classified objects along with their segmented boundaries.

The model detects objects' centroids on the maps, trained with Gaussian peak targets. This approach makes post-processing to locate objects simple, for example using an 8-neighbors peak detection due to the smoothness of the maps used in training. The centroids can be used as seeds for region growing on the segmentation maps so that, even when densely packed objects touch each other and are hard to segment, the seeds located at the centroids of the objects provide a good starting position for region growing to separate objects on the segmentation map.

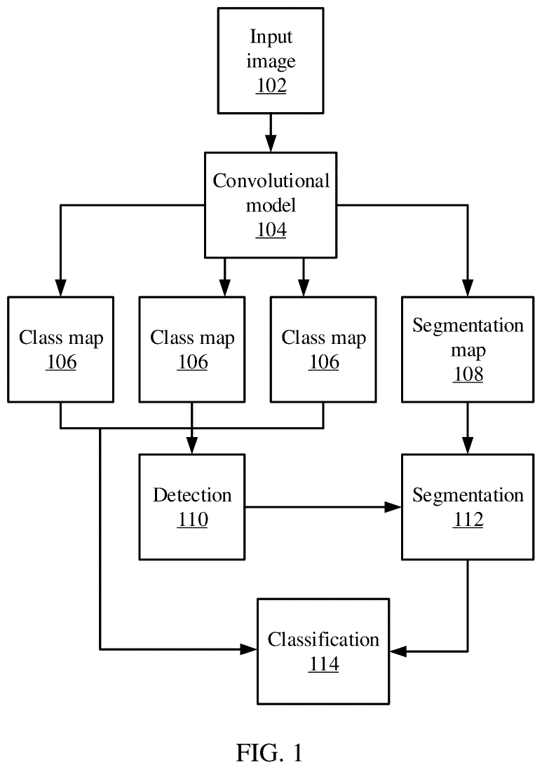

Referring now to FIG. 1, a diagram of the use of an image analysis model is shown. An input image 102 is processed by a convolutional model 104. The model 104 may be fully convolutional and may output a set of distinct maps, including N classification maps 106 and a segmentation map 108. The classification maps 106 locate and classify objects in the input image 102. The targets for the classification maps 106 are drawn as Gaussian peaks located at the centroids of the objects' annotations. A given class map 106 shows only objects in its respective class. The segmentation map 108 segments all detected objects from the background. The segmentation map 108 includes the objects' silhouettes.

Because the model 104 is fully convolutional, it can perform inference on images of any size and produce correspondingly sized output maps. Detection 110 is performed on the output classification maps 106, for example by combining all the classification maps 106 using a max operation. Because the targets used to train the model 104 are Gaussian peaks, the model 104 will reproduce those shapes during inference. Hence, for each object on the input image 102, a Gaussian peak will appear at its centroid on one of the output classification maps 106. Smooth peaks are easy to detect on a map by, e.g., checking the eight neighbor pixels for whether they are all smaller in intensity compared to the center pixel. If so, the center pixel is identified as a peak. Once all peaks have been identified by detection 110, the coordinates of those pixels are recorded in a list.

Segmentation 112 is performed on the segmentation map 108. The segmentation map 108 includes silhouettes of all objects in the input image 102. In some cases the silhouettes of multiple objects may touch one another, making it impossible to distinguish individual objects using the segmentation map alone. The peaks from detection 110 are used as seeds and region growing is used to identify boundaries between the objects. Region growing includes setting each seed as a different respective region and then adding layers to each region until they touch another region. Once the seeds are grown to fully occupy the regions indicated by the segmentation map 108, their contours are recorded and associated with their corresponding peak.

Classification 114 is then performed on all peaks by sampling all the classification maps 106 at the pixel coordinates of the peaks, thus collecting a vector of N logits. An argmax operation is performed on that vector to find the index having the largest value, which is the class of the object. A softmax operation can further be applied to provide probabilities. The class and its probability is recorded for each peak. Thus classification 114 outputs a list with entries containing the centroid location, class, and contour for all objects in the input image 102.

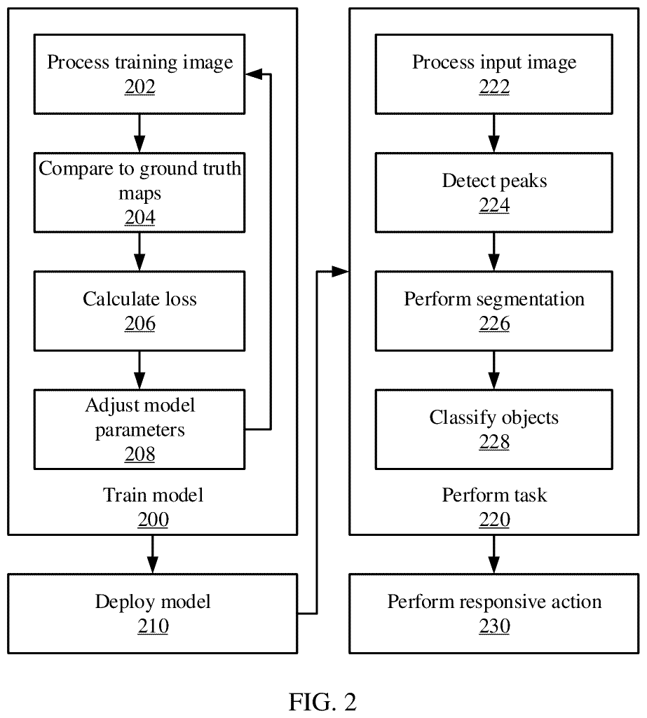

Referring now to FIG. 2, a method of training and using a combined object detection, classification, and segmentation model is shown. Block 200 trains the convolutional model 104 using an annotated training dataset. Training 200 includes processing 202 an image from the training dataset using the convolutional model 104. The resulting maps are compared to ground truth maps from the training dataset in block 204, for example identifying objects according to their classes and boundaries. Block 206 calculates a loss based on the difference between them, for example using a pixel-wise binary cross entropy loss for the classification maps 106 and a pixel-wise mean squared difference for the segmentation map 108. A total loss may be calculated as the sum of these. Block 208 then updates the parameters of the convolutional model, for example using the gradient of the loss at each layer of the model. This process repeats across the images in the training dataset, and may further be repeated multiple times across the entire training dataset until the loss on a validation dataset converges.

Block 210 deploys the model. This may include copying the trained parameters of the convolutional model 104 to a target system where inference will be performed. In embodiments where inference is performed at the same system where training is performed, the deployment step may be omitted.

Block 220 performs an image analysis task, for example performing object detection, classification, and segmentation simultaneously. Block 222 processes a new input image using the trained convolutional model 104. Block 224 then detects peaks in the class maps 106, for example using the eight-neighbor approach described above. Block 226 performs segmentation on the segmentation map 108, using the identified peaks as seeds and growing regions to identify boundaries between different objects. Block 228 then classifies the detected objects by associating the different objects of the segmentation with classes identified by the classification maps 106.

Block 220 performs an action responsive to the image. analysis. For example, the input image 102 may be of a stained tissue sample, with the classification identifying cells and, particularly, tumor cells. This can be used to determine a tumor cell ratio or other diagnostic information, which may then be used to devise and apply a treatment for a patient. In another example, the input image may be a satellite image, where vehicles and buildings can be identified and classified.

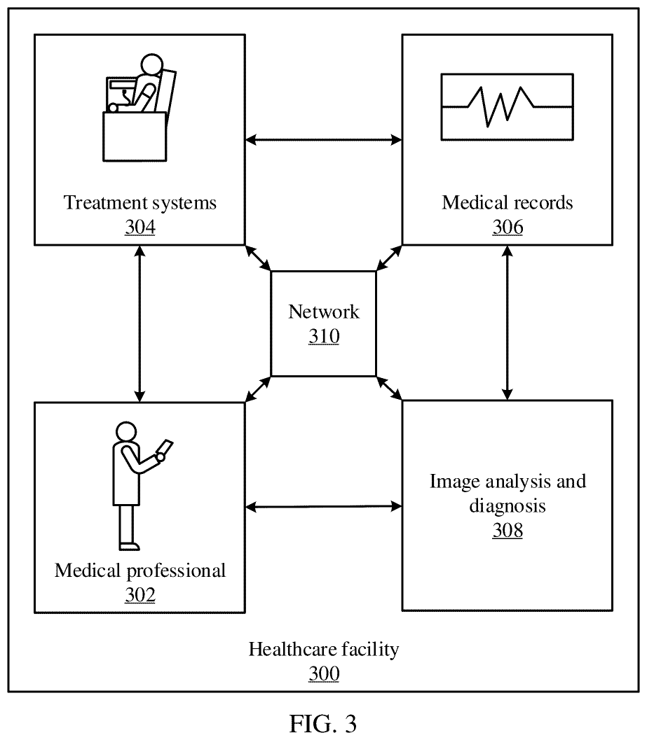

Referring now to FIG. 3, a diagram of information extraction is shown in the context of a healthcare facility 300. Image analysis and diagnosis 308 may be used to generate a custom treatment for a patient, responsive to information gleaned from tissue samples and the patient's medical records 306. The medical records 306 may include stained tissue samples images taken over a course of time to track the progression of disease.

The healthcare facility may include one or more medical professionals 302 who review information extracted from a patient's medical records 306 to determine their healthcare and treatment needs. These medical records 306 may include self-reported information from the patient, test results, and notes by healthcare personnel made to the patient's file. Treatment systems 304 may furthermore monitor patient status to generate medical records 306 and may be designed to automatically administer and adjust treatments as needed.

Medical professionals 302 may use image analysis and diagnosis 308 to provide customized healthcare that is tailored to the patient's needs. For example, the medical professionals 302 may use image analysis and diagnosis 308 to identify an action that will provide the best improvement to the patient's health state.

The different elements of the healthcare facility 300 may communicate with one another via a network 310, for example using any appropriate wired or wireless communications protocol and medium. Thus the image analysis and diagnosis 308 can be used to design a treatment that targets a patient's specific condition, for example using test results and medical records 306. The treatment systems 304 may be used to generate and administer a therapy based on image analysis and diagnosis 308.

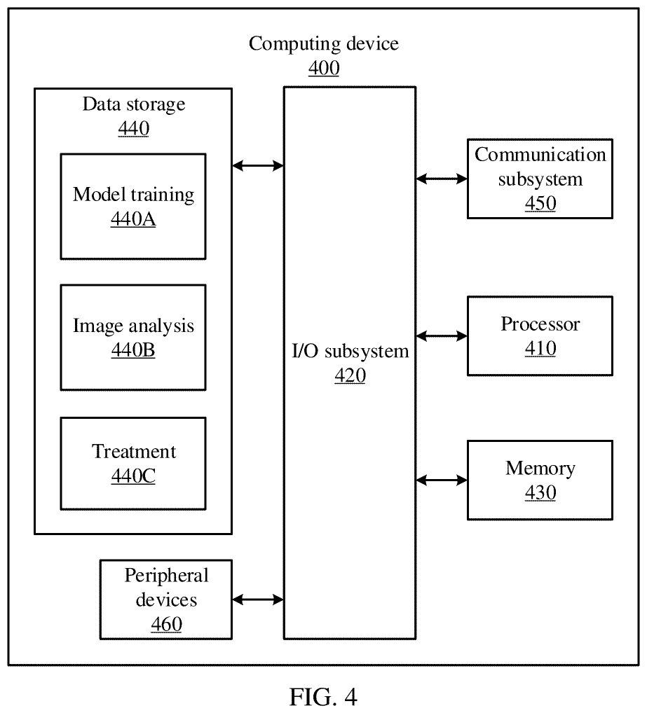

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for training the model, 440B for performing image analysis, and/or 440C for identifying and applying treatments for a patient. Any or all of these program code blocks may be included in a given computing system. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

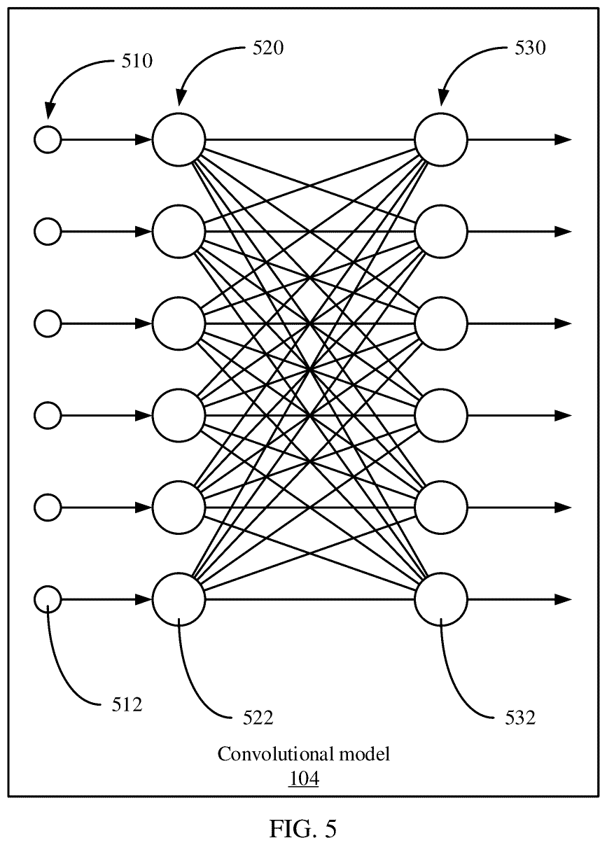

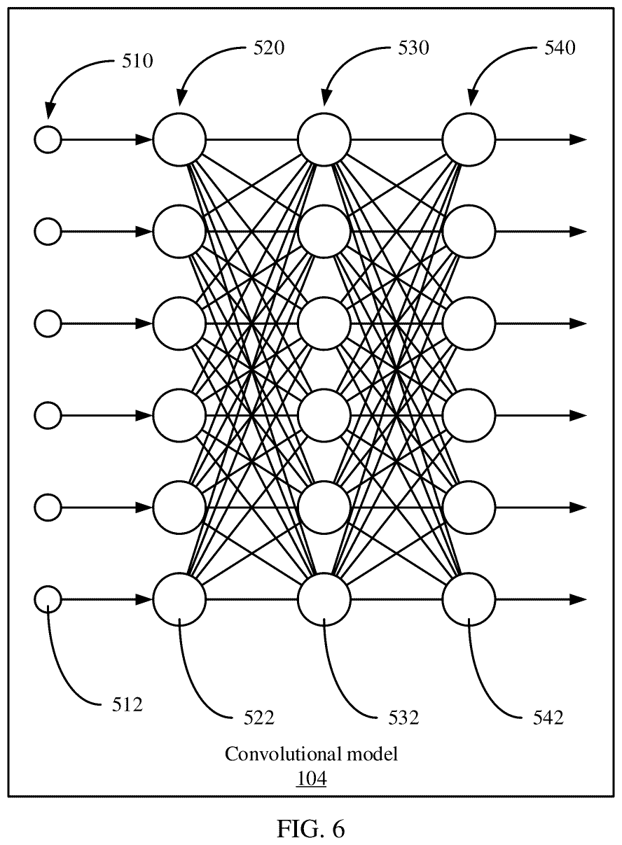

Referring now to FIGS. 5 and 6, exemplary neural network architectures are shown, which may be used to implement parts of the present models, such as the convolutional model 104. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium, so configured, causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for image analysis, comprising:
processing an input image with a convolutional model that generates a plurality of classification maps and a segmentation map;
identifying pixels in the classification maps that correspond to intensity peaks to detect objects;
generating object boundaries in the segmentation map around the pixels to segment objects; and
classifying objects using the object boundaries and the pixels to associate regions of the input image with respective classes; and
performing an action responsive to the objects.

2. The method of claim 1, wherein identifying the pixels includes performing an eight-neighbor comparison for pixels of the input image and selecting pixels that have a greater intensity than the eight neighbors.

3. The method of claim 1, wherein the plurality of classification maps includes a separate classification map for each of the classes.

4. The method of claim 1, wherein generating the object boundaries includes region growing in the segmentation map using the pixels as seeds.

5. The method of claim 1, wherein the convolutional model is a fully convolutional model that outputs the classification maps and the segmentation map with a same size as the input image.

6. The method of claim 1, wherein the input image is a stained tissue sample and the objects are cells.

7. The method of claim 6, wherein the classes include tumor cells and healthy cells.

8. The method of claim 7, wherein performing the action includes performing a treatment for a disease based on classification of the objects, including tumor cells.

9. The method of claim 1, further comprising combining the classification maps, before identifying the pixels, by taking maximum intensity values of respective pixels across the plurality of classification maps.

10. The method of claim 1, wherein classifying the objects includes determining a classification map that has a highest intensity for each of the pixels.

11. A system for image analysis, comprising:
a hardware processor; and
a memory that stores a computer program which, when executed by the hardware processor, causes the hardware processor to:
process an input image with a convolutional model that generates a plurality of classification maps and a segmentation map;
identify pixels in the classification maps that correspond to intensity peaks to detect objects;
generate object boundaries in the segmentation map around the pixels to segment objects; and
classify objects using the object boundaries and the pixels to associate regions of the input image with respective classes; and
perform an action responsive to the objects.

12. The system of claim 11, wherein identification of the pixels includes an eight-neighbor comparison for pixels of the input image and selecting pixels that have a greater intensity than the eight neighbors.

13. The system of claim 11, wherein the plurality of classification maps includes a separate classification map for each of the classes.

14. The system of claim 11, wherein generation of the object boundaries includes region growing in the segmentation map using the pixels as seeds.

15. The system of claim 11, wherein the convolutional model is a fully convolutional model that outputs the classification maps and the segmentation map with a same size as the input image.

16. The system of claim 11, wherein the input image is a stained tissue sample and the objects are cells.

17. The system of claim 16, wherein the classes include tumor cells and healthy cells.

18. The system of claim 17, wherein the action includes a treatment for a disease based on classification of the objects, including tumor cells.

19. The system of claim 11, wherein the computer program further causes the hardware processor to combine the classification maps, before identifying the pixels, by taking maximum intensity values of respective pixels across the plurality of classification maps.

20. The system of claim 11, wherein classification of the objects includes determination of a classification map that has a highest intensity for each of the pixels.
